(19) United States
(12) Patent Application Publication
(10) Pub. No.: US 2021/0082294 A1
(43) Pub. Date: Mar. 18, 2021

(54) AIR TRAFFIC PROXIMITY DETECTION

(71) Applicant: Air Traffic Awareness, Kansas City, MO (US)

(72) Inventors: Cameron James Knight, Kansas City, MO (US); Kashif Hasnie, Overland Park, KS (US); Merwan Abdelmajeed, Lawrence, KS (US); Tonderai Frank Kambarami, Kansas City, MO (US)

(21) Appl. No.: 17/023,007

(22) Filed: Sep. 16, 2020

Related U.S. Application Data
(60) Provisional application No. 62/901,732, filed on Sep. 17, 2019.

(51) Int. Cl. G08G 5/00; G08G 5/04

(52) U.S. Cl. CPC G08G 5/0078; G08G 5/0021; G08G 5/0069; G08G 5/045; G08G 5/006

(57) ABSTRACT

An air traffic proximity device operates at a local aircraft to track remote aircraft proximate to the local aircraft. A receiver captures a received signal, such as an ADS-B signal, transmitted by a remote aircraft. The device parses the received signal to determine location data and velocity data indicating location and velocity of the remote aircraft, and determines a relative position of the remote aircraft as a function of a position of the local aircraft. Based on this relative position, the remote aircraft is assigned to a proximity zone as a function of a distance between the local aircraft and the remote aircraft, velocity of the local aircraft, and velocity of the remote aircraft. A display provides a representation of the remote aircraft positioned relative to the location and velocity of the local aircraft, as well as a representation of the proximity zone encompassing the representation of the remote aircraft.

### RELATED APPLICATION

This application claims the benefit of U.S. Provisional Application No. 62/901,732, filed on Sep. 17, 2019. The entire teachings of the above application are incorporated herein by reference.

### BACKGROUND

The Federal Aviation Administration (FAA) mandates that all aircraft flying in any controlled airspace within the territory of the United States have an Automatic Dependent Surveillance Broadcast (ADS-B) collision avoidance system installed. ADS-B comprises transmission and reception services—ADS-B Out and ADS-B In. ADS-B Out provides periodic transmission and broadcast of an aircraft's movement and location information, such as altitude, velocity and heading, along with other aircraft identifying information. ADS-B In is the reception of ADS-B Out data by aircraft or other receivers sufficiently proximate to the aircraft broadcasting the ADS-B Out transmissions. ADS-B receivers may be either portable or installed within an aircraft, but they require either Global Positioning System (GPS) and/or Wireless Fidelity (WiFi) reception to locate other airborne aircraft. Such signals may not always be readily and reliably available. Therefore, there exists a need for an aircraft detection scanner that is handheld and portable, notifies the user of other significantly proximate aircraft, and that does not require either GPS or WiFi reception, but rather can rely solely on ADS-B Out signal reception.

### SUMMARY

Example embodiments include a method of tracking remote aircraft. At a local aircraft, a received signal, transmitted by a remote aircraft, may be parsed to determine location data and velocity data indicating location and velocity of the remote aircraft. A relative position of the remote aircraft may then be determined as a function of a position of the local aircraft. The remote aircraft may be assigned to a proximity zone as a function of 1) a distance between the local aircraft and the remote aircraft, 2) velocity of the local aircraft, and 3) velocity of the remote aircraft. At the local aircraft, 1) a representation of the remote aircraft positioned relative to the location and velocity of the local aircraft, and 2) a representation of the proximity zone encompassing the representation of the remote aircraft, may be displayed.

The received signal may be an automatic dependent surveillance-broadcast (ADS-B) signal. The ADS-B signal transmitted by the local aircraft may be parsed to determine the position and velocity of the local aircraft. The proximity zone may be one of a plurality of proximity zones, and the plurality of proximity zones may be displayed as a plurality of layers encompassing a representation of the local aircraft.

The proximity zone may be a first proximity zone, in response to detecting a change in velocity of at least one of the local aircraft and the remote aircraft, the remote aircraft may be assigned to the second proximity zone. A representation of a movement of the remote aircraft from the first proximity zone to the second proximity zone may be displayed at the local aircraft.

An audible cue may be emitted in response to assigning the remote aircraft to the proximity zone, wherein a characteristic of the audio cue may be a function of the proximity zone. In response to an action by a user at the local aircraft, information corresponding to the remote aircraft may be displayed at the local aircraft, the information including at least one of a speed, a name, and a heading of the remote aircraft. The representation of the remote aircraft may be updated based on a change in the velocity of the local aircraft. The representation of the remote aircraft may be positioned at a display as a function of a position of a representation of the local aircraft.

The local aircraft and the remote aircraft may be at least one of an airplane, a helicopter, a lighter-than-air vehicle, an advanced air mobility vehicle, a vertical take-off and landing (VTOL), and an unmanned aerial vehicle (UAV).

Example embodiments may further include a system or device for tracking remote aircraft. A radio receiver may be configured to capture, at a local aircraft, a received signal transmitted by a remote aircraft. A controller may be configured to 1) parse the received signal to determine location data and velocity data indicating location and velocity of the remote aircraft, 2) determine a relative position of the remote aircraft as a function of a position of the local aircraft; and 3) assign the remote aircraft to a proximity zone as a function of a) a distance between the local aircraft and the remote aircraft, b) velocity of the local aircraft, and c) velocity of the remote aircraft. A display, such as a touch screen, may be configured to display, at the local aircraft, 1) a representation of the remote aircraft positioned relative to the location and velocity of the local aircraft, and 2) a representation of the proximity zone encompassing the representation of the remote aircraft.

The controller may be further configured to parse an ADS-B signal transmitted by the local aircraft to determine the position and velocity of the local aircraft. The proximity zone may be one of a plurality of proximity zones, the display may be further configured to display the plurality of proximity zones as a plurality of layers encompassing a representation of the local aircraft. The proximity zone may be a first proximity zone, and the controller may be further configured to, in response to detecting a change in velocity of at least one of the local aircraft and the remote aircraft, assigning the remote aircraft to the second proximity zone. The display may be further configured to display, at the local aircraft, a representation of a movement of the remote aircraft from the first proximity zone to the second proximity zone.

The controller may be further configured to cause an audible cue to be emitted in response to assigning the remote aircraft to the proximity zone, a characteristic of the audio cue being a function of the proximity zone. The display may be further configured to, in response to an action by a user at the local aircraft, display information corresponding to the remote aircraft, the information including at least one of a speed, a name, and a heading of the remote aircraft.

The controller may be further configured to update the representation of the remote aircraft based on a change in the velocity of the local aircraft. The display may be further configured to display the representation of the remote aircraft being positioned as a function of a position of a representation of the local aircraft.

Example embodiments may further include a computer-readable medium storing instructions that, when executed by a computer system, cause the computer system to perform one or more of the aforementioned operations.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic view of an air traffic proximity detector, including internal components, in one embodiment.

FIG. 2A is a front view of the air traffic proximity detector.

FIG. 2B is a front view of the air traffic proximity detector displaying a user interface (UI).

FIG. 3 is a diagram illustrating selected elements of an air traffic proximity detection system.

FIG. 4A is a flow diagram of a process of detecting and classifying remote aircraft in one embodiment.

FIG. 4B is a flow diagram of a process of operating a device in one embodiment.

FIG. 5A is an illustration of a detector display and graphic user interface.

FIG. 5B is an illustration of a detector display and graphic user interface showing aircraft in a Safe zone approaching a Watch zone.

FIG. 5C is an illustration of a detector display and graphic user interface showing aircraft entering the Watch zone.

FIG. 5D is an illustration of a detector display and graphic user interface showing aircraft entering a Warning zone with pulse and change in speed.

FIG. 5E is an illustration of a detector display and graphic user interface showing aircraft still in the Warning zone and information about the aircraft.

FIG. 5F is an illustration of a detector display and graphic user interface showing aircraft entering a Danger zone with alarm.

### DETAILED DESCRIPTION

A description of example embodiments follows.

Example embodiments described herein can provide a user with the ability to monitor live aircraft traffic in the air and prevent collisions using a single portable unit without the aid or necessity of GPS or WiFi. For example, some embodiments may operate using received aircraft-generated communications signals, such as ADS-B signals, and may operate independently of other wirelessly transmitted information.

A detector device according to an example embodiment may be particularly advantageous for in-flight use, and is simple to use and easily accessible to a pilot. Embodiments of an air traffic proximity detector (scanner) according to the example embodiments may include an antenna, optimally having a 5 decibel (dB) gain and tuned to 1090 MegaHertz (MHz), and providing signal to a Software Defined Radio (SDR) receiver, such as a Register-Transfer Level (RTL)-SDR receiver. The SDR may also be pre-tuned to 1090 MHz. The SDR serves to connect the antenna to an integrated circuit, such as a System on a Chip (SoC) and optionally to a Raspberry Pi® computer. The SoC may be programmed using an embedded Linux system and may include a Central Processing Unit (CPU), a Graphics Processing Unit (GPU), Random Access Memory (RAM), radio frequency signal processing functions and storage, such as via a microSD card. Graphics, including text and images, generated by the SoC may be displayed on a touch screen display via the screen circuit board. Connectivity between the SoC and touch screen may be via High-Definition Multimedia Interface (HDMI) or other practicable means. Power to the detector is provided by a power supply including a battery or batteries, such as a rechargeable lithium-ion battery, a power converter and a Universal Serial Bus (USB) port for recharging the batteries. Certain embodiments of the detector may include a speaker and/or a headphone jack for receiving analog audio signals provided by the SoC, or a peripheral USB audio card.

The device may be configured (e.g., via software operating at the SoC) to receive air traffic information via ADS-B Out signals received from nearby aircraft via the detector antenna and SDR receiver. The device may determine the proximity of such nearby aircraft and assign a zone identifier to each. In certain embodiments, the device may define three zones of proximity inside the Safe zone: Watch, Warning and Danger. Indicia indicating the assigned zone of proximity associated with each detected aircraft may be displayed at the detector's touch screen.

A further embodiment can be implemented in any of these various computing devices, and it can connect to an ADS-B receiver with a wired or wireless connection, such as bluetooth.

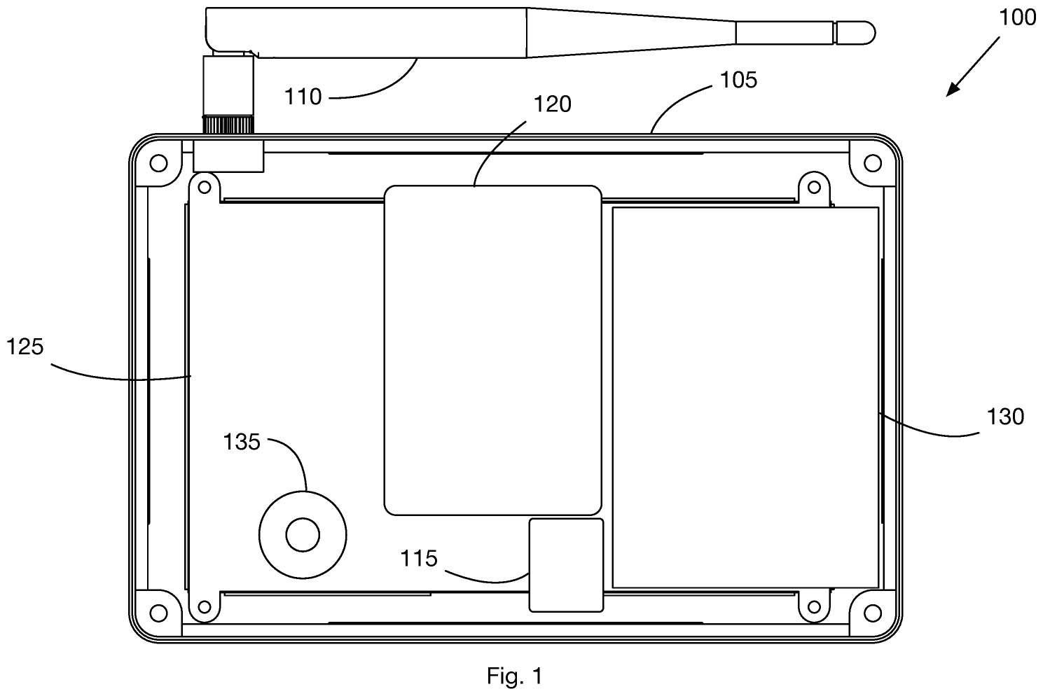

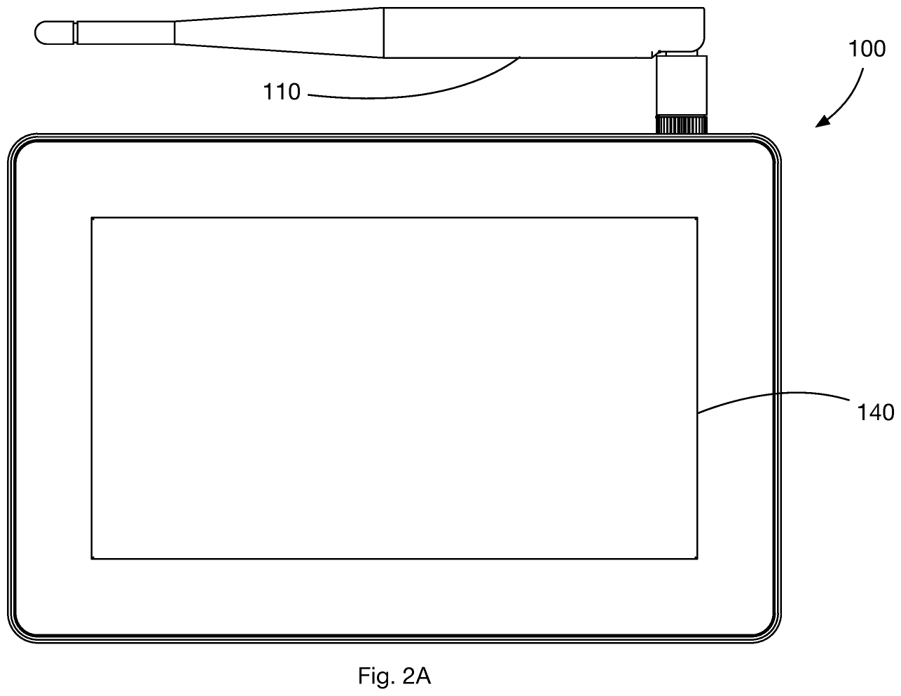

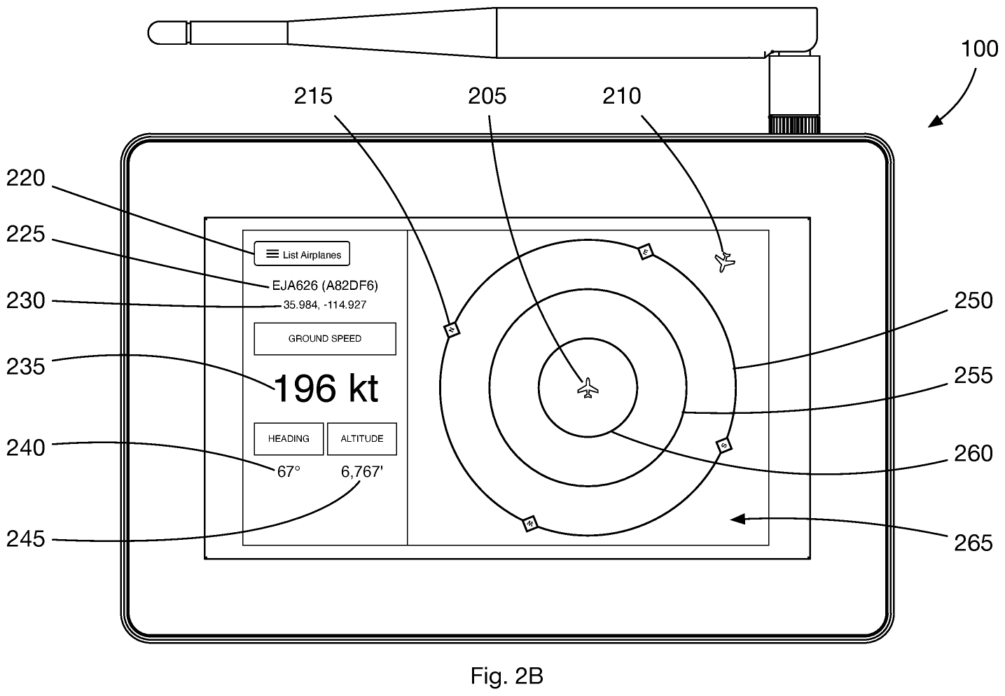

FIG. 1 is a schematic view of an air traffic proximity detector device 100, including internal components, in an example embodiment. The device 100 may include a case 105 formed of plastic or other resilient material, an antenna 110 attached to the exterior of the case, a software-defined radio (SDR) receiver 115 housed within the case 105 and connected via electrical conductors through the body of the case 105 to the antenna 110, a controller (e.g., a system-on-chip (SoC)) 120 electronically connected to the SDR receiver 115 and also to the display circuit board 125 of a display such as a touch screen as illustrated in FIGS. 2A-B, described below.

The antenna 110, in one configuration, may have a 5 decibel (dB) gain and is tuned to 1090 MHz. The antenna 110 provides a signal to an SDR receiver 115, such as an RTL-SDR receiver. The SDR 115 may also be pre-tuned to 1090 MHz. The SDR 115 serves to connect the antenna 110 to an integrated circuit, such as an controller 120. If the SDR 115 is not pre-tuned, software running on the controller 120 may be used to pull signal data only at 1090 MHz. In certain embodiments of the device 100, the SDR 115 may be replaced by an integrated radio receiver.

The controller 120 may include a CPU, GPU, RAM, radio frequency signal processing functions and storage, such as via a microSD card. In some embodiments of the device 100, an controller 120 is provided via a microcomputer known in the prior art by the trademark and trade name Raspberry Pi®.

Exemplary specifications for a Raspberry Pi® 3 include the following:
a) SoC: Broadcom BCM2837
b) CPU: 4×ARM Cortex-A53, 1.2 GHz
c) GPU: Broadcom VideoCore IV
d) RAM: 1 GB LPDDR2 (900 MHz)
e) Networking: 10/100 Ethernet, 2.4 GHz 802.11n wireless
f) Bluetooth: Bluetooth 4.1 Classic, Bluetooth Low Energy
g) Storage: microSD
h) GPIO: 40-pin header, populated

Power to the device 100 is provided by a power supply 130 including a battery or batteries (e.g., rechargeable batteries), a power converter, and a USB port or a Direct Current (DC) barrel jack for recharging the batteries. In some embodiments of the device 100, the power supply 130 will include a battery or battery pack supplying 3.3 volts and 10,000 milliAmpere hours (mAh), and a power converter output of 5 volts at 2 amperes.

Certain embodiments of the device 100 may include a speaker 135 and/or a headphone jack for receiving analog audio signals provided by the controller 120, or a peripheral USB audio card. Ports provided on the device 100 may include HDMI, 3.5 mm analog audio-video jack, USB, Ethernet, Camera Serial Interface (CSI), and Display Serial Interface (DSI).

Software program running on SoC 104 receives air traffic information via ADS-B Out signals received from nearby aircraft via the antenna 110 and SDR receiver 115.

FIGS. 2A-B illustrate a front view of the device 100 in an assembled configuration. Here, a touch screen 140 occupies the front surface of the device 100. With reference to FIG. 1, graphics, including text and images, generated by the controller 120 are displayed at the touch screen 140 via the display circuit board 125 mounted on the back surface of the touch screen 140. Connectivity between the controller 120 and touch screen 140 may be by HDMI or another communications interface. Exemplary specifications of a device 100 touch screen 140 include a diagonal screen width of 7 inches, 800×400 or greater resolution, color, either capacitive or resistive touch sensitivity, and HDMI or other connectivity to the controller 120. FIG. 2A illustrates the device 100 with the touch screen 140 switched off.

FIG. 2B is a front view of the device 100 displaying an example user interface (UI). The UI may display relevant information for the pilot. The UI shows the local aircraft 205 and a remote aircraft 210. The orientation of the local aircraft 205 can be discerned by the compass 215 or by the heading 240. Additional real-time data about the local aircraft 205 is also displayed, such as, altitude 245, ground speed 235, latitude and longitude 230, and tail number 225. The potential threat of a remote aircraft 210 can be quickly determined by its zone: Safe Zone 265, Watch Zone 250, Warning Zone 255, or Danger Zone 260.

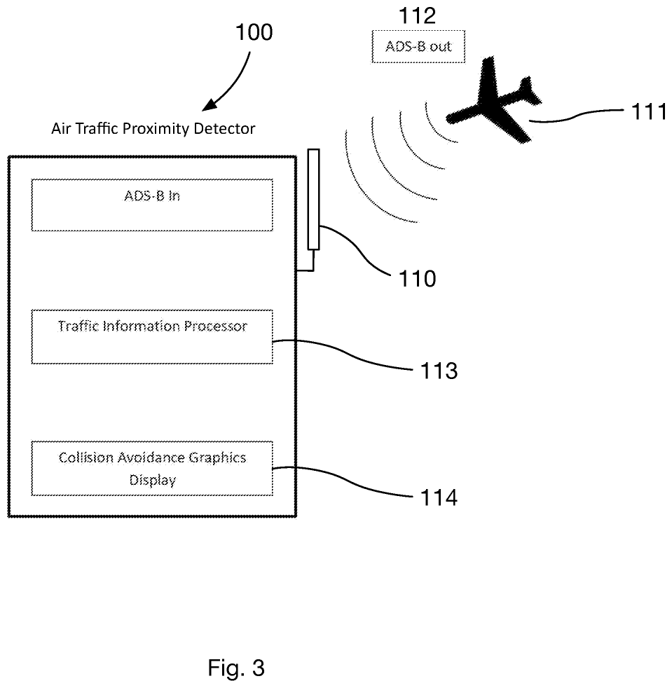

FIG. 3 is a block diagram illustrating selected elements of an air traffic proximity detection system in an operational environment, including the device 100 and a remote aircraft 111 broadcasting an ADS-B Out transmission 112. With reference to FIG. 1, the ADS-B Out transmission 112 is received by the antenna 110 to an ADS-B input (e.g., the SDR receiver 115) of the device 100 when the device 100 is sufficiently proximate to the remote aircraft 111. The controller 120 may implement a traffic information processor 113, in hardware and/or software, that determines the proximity of all such nearby remote aircraft 111 and assigns a zone identifier to each. In certain embodiments of the present invention, the software defines three zones of proximity: a Watch zone, a Warning zone, and a Danger zone. Any aircraft outside of these three defined zones may be designated as a Safe zone. Further embodiments may implement additional zones, or may condense the three zones into one or two zones. The touch screen 140 may implement a collision avoidance graphics display function 114 to display indicia indicating the assigned zone of proximity associated with each remote aircraft.

Example embodiments may operate a process described herein to determine aircraft proximity and assess safety. In one embodiment, a process operated by the controller 120 (e.g., a conflict algorithm) may utilize a haversine formula to calculate the distance between two aircraft located at two points, each point defined by latitude and longitude coordinates.

The controller 120 may also implement a process to determine the proximity zone based upon the local aircraft velocity. For each remote aircraft, and given a device in an example embodiment in operation on a local aircraft, the process may operate as follows:

1. The remote aircraft is ignored if the difference in altitude between the remote aircraft and local aircraft indicates significant vertical separation.

2. The latitude and longitude (geographic coordinate) of the remote aircraft and local aircraft is used to determine the horizontal distance.

3. A proximity label is applied in the detector software referencing the remote aircraft based on its horizontal distance to the remote aircraft and the local aircraft velocity.

4. The geographic coordinate of the remote aircraft is converted to the Cartesian coordinate of the user interface with respect to the local aircraft at the origin.

Distances between remote aircraft and local aircraft are assigned a zone, and are indicated as safe or not safe, based on predetermined criteria. In certain embodiments, there are three zones: a Watch zone, a Warning zone, and a Danger zone. Determination of zone assignment may be dynamic, and may be a function of aircraft speed, especially relative to one another. Zones can be standard FAA recommended zones (3 Nautical Miles—NM, 6 NM, or 9 NM) or special speed-configured zones. Vertical separation may be used to filter out remote aircraft if a remote aircraft is greater than 1000 feet above the local aircraft.

A further embodiment of the scanner includes a Bluetooth connection to connect a prior art computing device, such as a cell phone, notebook, tablet, or laptop, to a prior art ADS-B receiver. Proprietary software according to the present invention will operate on the computing device.

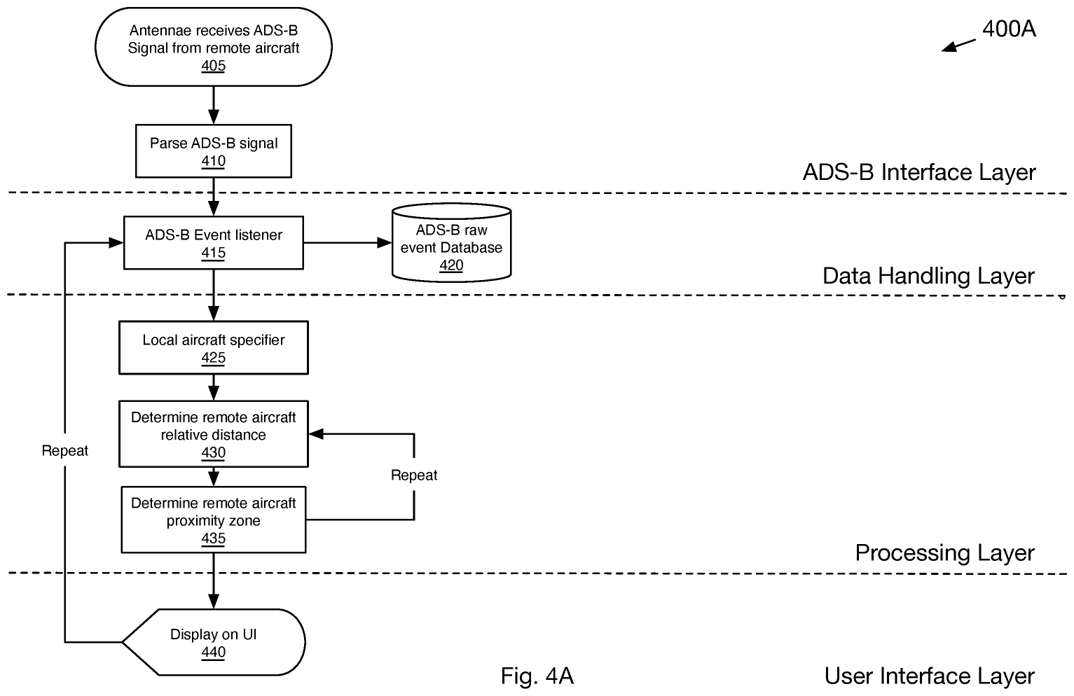

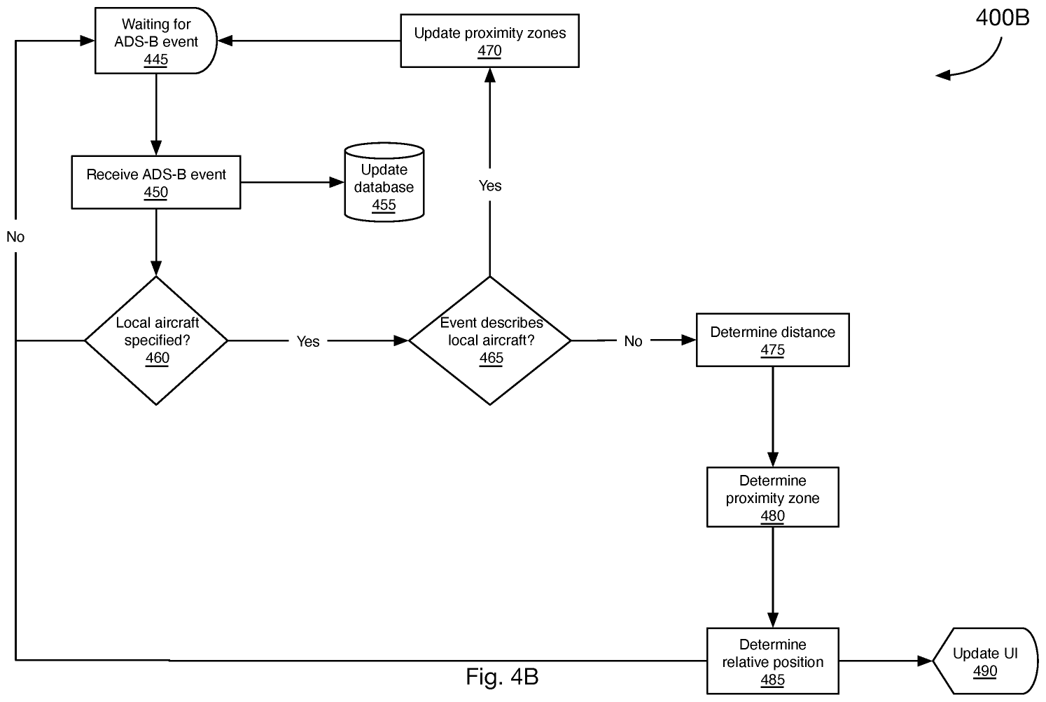

FIG. 4A is a flow diagram of a process 400A of detecting and classifying remote aircraft, which may be operated by the device 100 described above with reference to FIGS. 1 and 2A-B. The ADS-B Interface layer corresponds to the antenna 110 and the device 100. The data handling and processing layer may be operated by the controller 120 in hardware and/or software, while the UI layer corresponds to the output displayed on the touch screen 140. With reference to FIG. 1, the device 100 may receive a signal transmitted by a remote aircraft via the antenna 105 (405). The signal may be a radio frequency signal having a frequency in the range of 900 MHz to 1200 MHz, such as an ADS-B signal having a frequency of 1090 MHz. The ADS-B event is parsed via a corresponding protocol (e.g., GDL90, Dump1090), to determine location data and velocity data indicating location and velocity of the remote aircraft 410. Each ADS-B event payload can be composed of information regarding multiple aircraft. The raw signal is passed to the data handling layer, where the proprietary event listener 415 lives, which remains in an idle state until an ADS-B event is received. Once received the event handler 415 then stores the ADS-B event in the database 415. The database 415 can be composed of any transactional, or non-transactional based technology e.g. SQLite, or Firebase. The proprietary event listener 415 also passes a copy to the processing layer of the application. The processing layer is described in further detail below with reference to FIG. 4B. ADS-B events are processed by the local aircraft specifier 425 to determine whether or not the event corresponds to the local aircraft or not. For each remote aircraft in the ADS-B payload, the controller 120, operating a processing engine at the processing layer, calculates the relative distance between the remote aircraft and local aircraft (430) in Cartesian coordinates. Then the controller 120 determines the remote aircraft's proximity zone (435) in relation to the local aircraft. This information is then passed on the UI where it is displayed (440) on the UI layer, where the user interacts with the screen of the device 140. This flow is repeated for every single ADS-B event, whereby within each event/payload, the processing layer runs all calculations for each aircraft in the payload.

FIG. 4B is a flow diagram illustrating a process 400B that may be carried out by the processing layer in further detail. The proprietary event listener 415 remains in an idle state whenever the device is powered on (445). Once the event listener 415 receives an ADS-B event (450), the database 420 is updated (455) with the contents of the ADS-B payload. The event is then consumed by the local aircraft specifier 425, which determines whether aircraft in the payload (if any) refer to the local aircraft. If no local aircraft is specified, then the proprietary event listener 415 goes back into an idle state waiting for events (445). If the local aircraft is specified, then the controller 120 may recursively check each aircraft in the event to determine if that aircraft describes the local aircraft (465). If the aircraft is confirmed as the local aircraft, the controller 120 updates the proximity zones based on the velocity of the local aircraft (470). If the aircraft in the event is confirmed as being a remote aircraft, the controller 120 may proceed through a series of decisions:

1. To determine the distance from the remote aircraft to the local aircraft (475).

2. To determine which proximity zone the remote aircraft belongs to (480).

3. To determine the relative position for which the remote aircraft needs to be rendered on the UI (485).

The corresponding remote aircraft are displayed in the predetermined proximity zone on the UI displayed by the touch screen 140 (490).

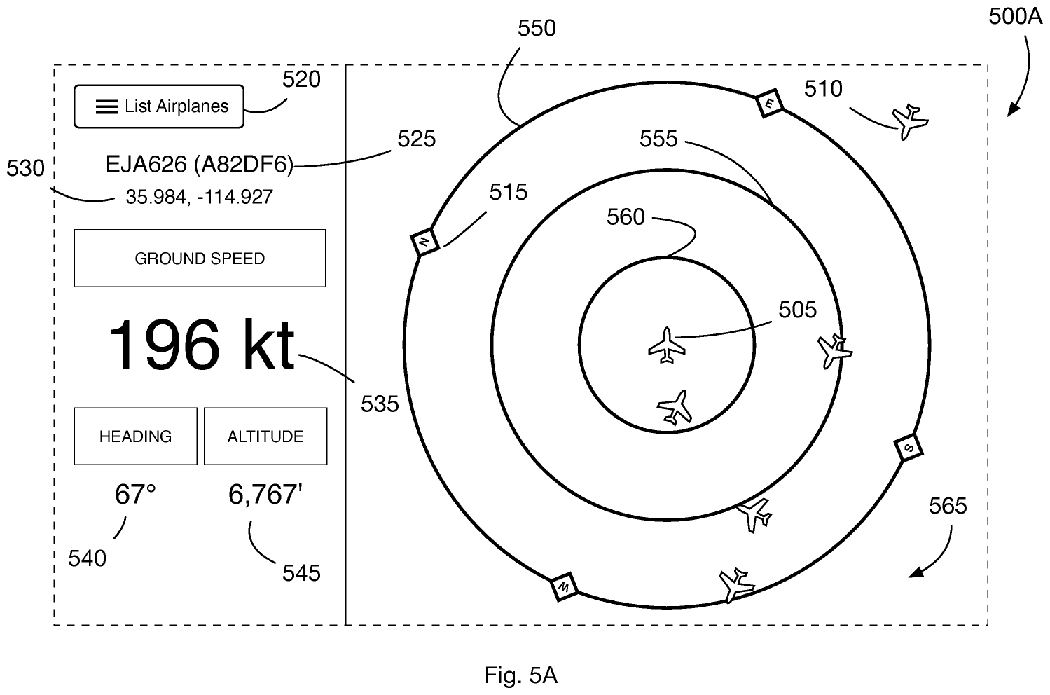

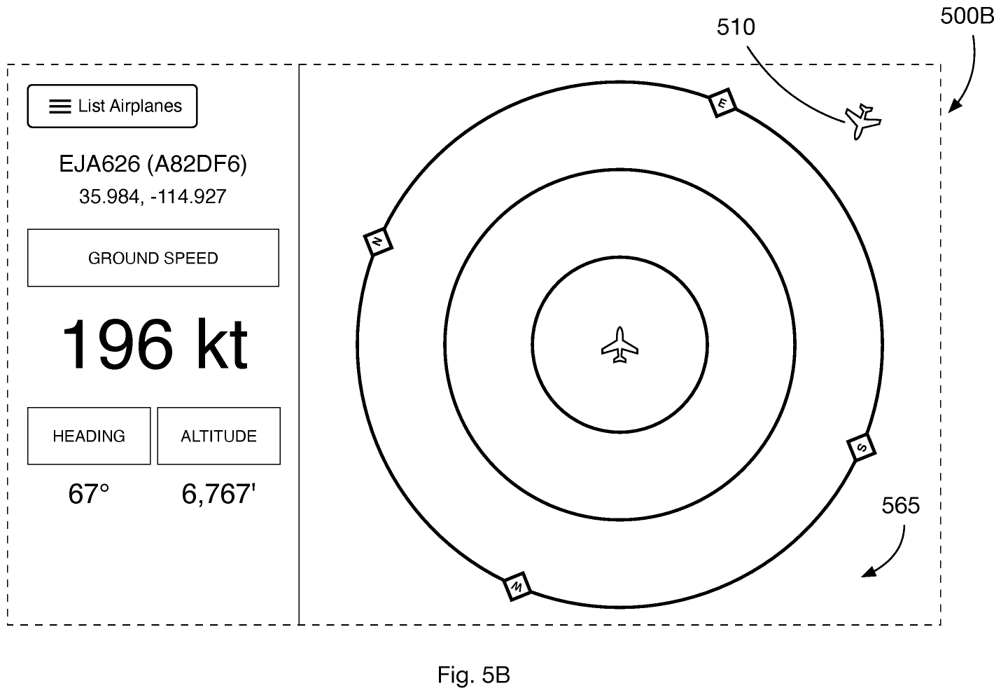

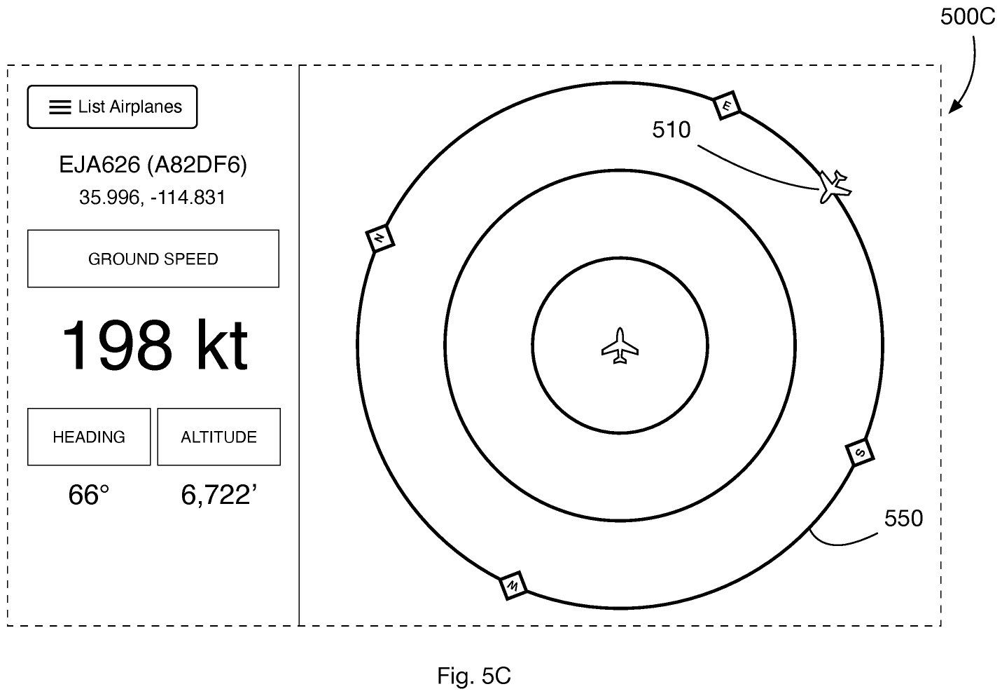

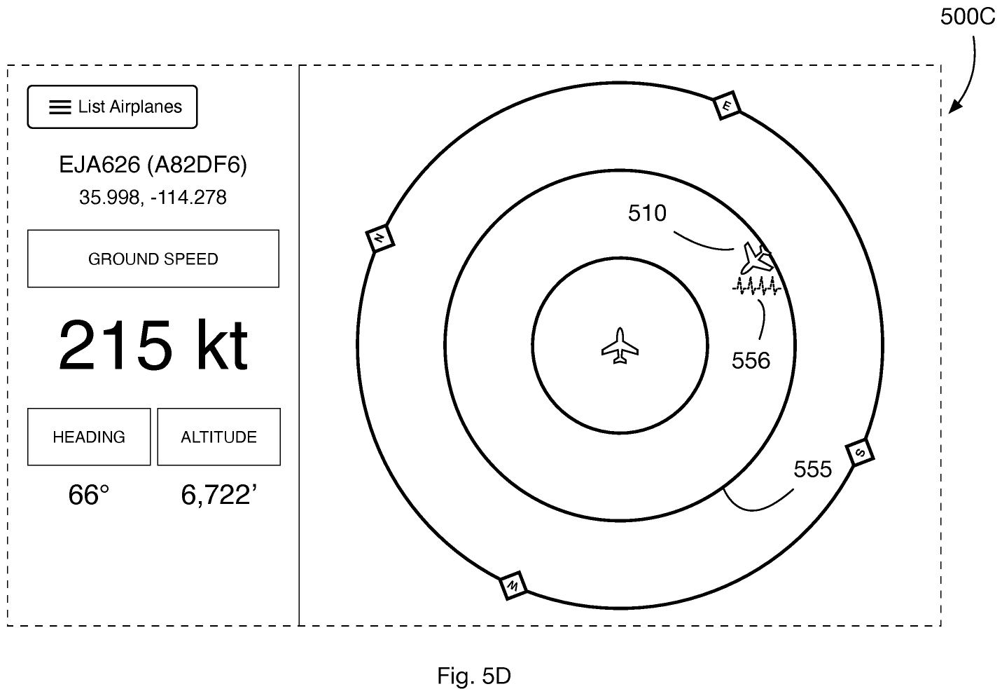

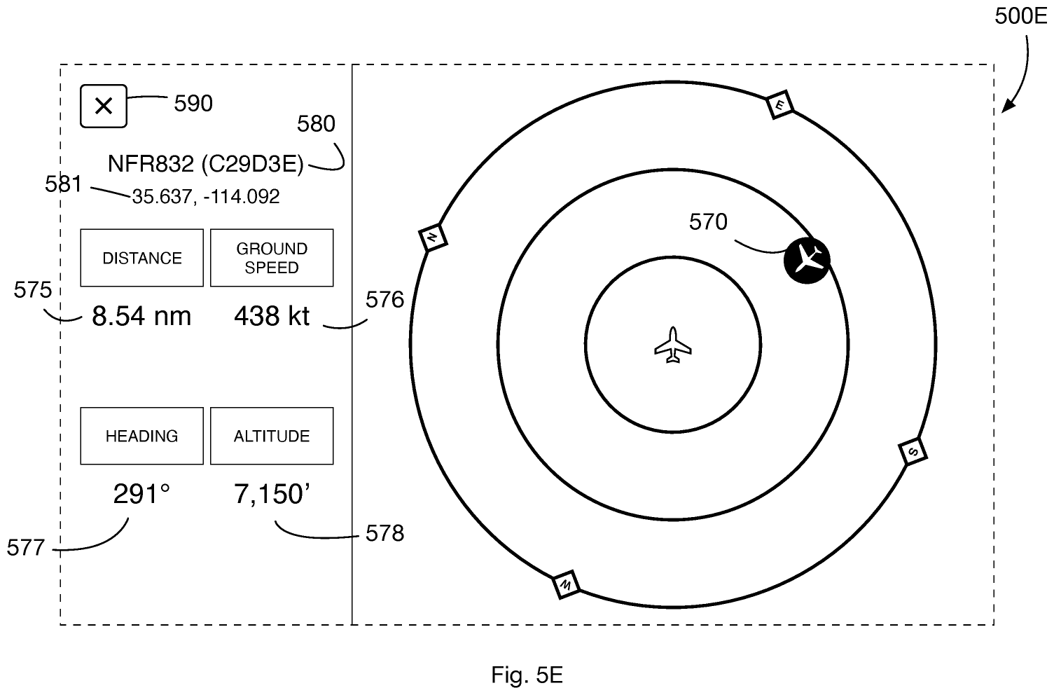

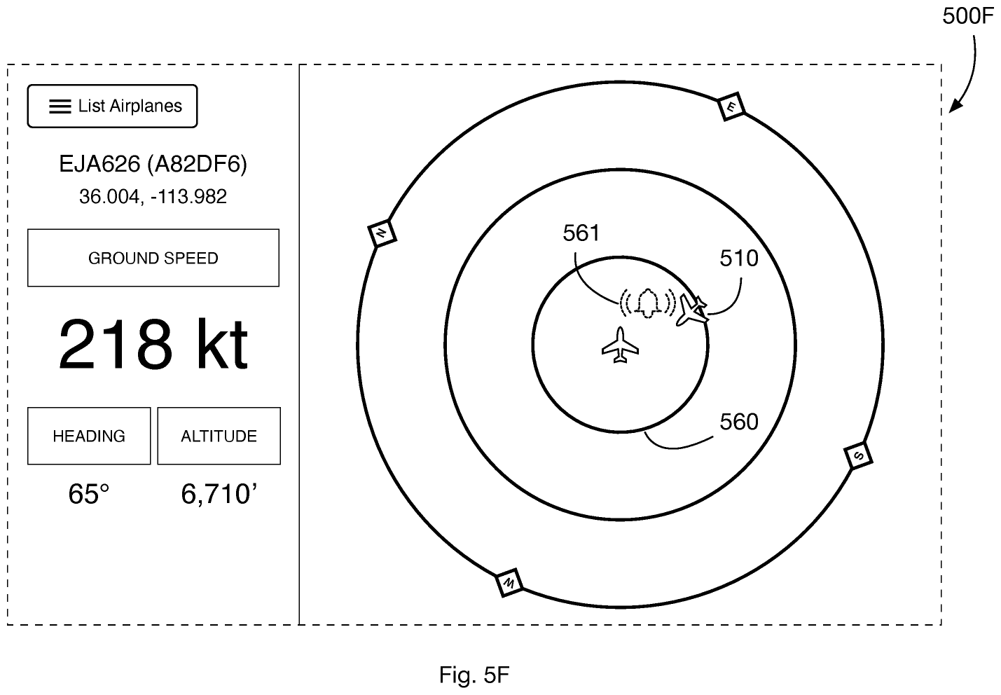

FIG. 5A illustrates an example UI 500A that may be displayed by the device 100 at the touch screen 140. The UI 500A presents a representation of a local aircraft 505, shown as an icon of an aircraft centered in the screen. A plurality of remote aircraft, including a remote aircraft 510, are also displayed as icons surrounding the local aircraft 505 at the UI 505A A pilot interacting with the device 100 can determine which direction each of the remote aircraft are travelling at a glance by referring to a compass 515 and also the heading 540. The local aircraft can maintain a fixed position on the screen, and the compass and remote aircraft reorient themselves around the local aircraft dependent upon the local aircrafts heading and ground speed. The UI shows the proximity of the local aircraft to the remote aircraft. The UI uses zones to relay this information quickly to the pilot.

The local aircraft 505 is rendered in the center of the UI, and represents the local aircrafts current position. The heading 540, ground speed 535, altitude 545 and tail number 525 are displayed on the left-hand side. All other rendered aircraft represent remote aircraft. The orientation of the remote aircraft is a function of the relative velocity to the local aircraft as determined by the controller 120. The position of the remote aircraft is a function of the remote aircraft's relative position, and the local aircraft velocity.

Multiple zones are used; the Safe zone 565 (more than 9 NM), the Watch zone 550 (within a minimum of 9 NM) the Warning zone 555 (within a minimum of 6 NM) and a Danger zone 560 (within a minimum of 3 NM). Additional details about the local aircraft are provided to the pilot, such as the ground speed 530, the heading 540, the altitude 545, the latitude and longitude 530 and the tail number 525. The pilot can find about remote aircraft by observing the icons on the screen or tapping the ‘List Aircraft’ option 520. Additional details on the remote aircraft can be accessed by other means as described below with reference to FIG. 5E. FIGS. 5B-5F illustrate a scenario wherein the local aircraft 505 encounters the remote aircraft 510 through several stages.

FIG. 5B illustrates a UI 500B displaying a scenario in which a remote aircraft 510 is travelling in the Safe zone with regards to the local aircraft. The Safe zone may be designated to encompass all air space that is more than 9 NM away from the local aircraft 505, which at speeds of 196 kt. (per example) is sufficient time for the pilot to make corrective action(s) if aircraft are on a collision course. The bounds of the Safe zone, similarly to the bounds of the other zones, can be updated as a function of the velocity of the local aircraft 505 and/or the velocity of the remote aircraft. For example, inner bound of the Safe zone can be defined as further than 9 NM away if the local aircraft's speed is above a predetermined threshold. Aircraft in the Safe zone are not considered a threat.

FIG. 5C illustrates a UI 500C displaying a scenario where the remote aircraft crosses the boundary between the Safe zone and Watch zone 550. The Watch zone indicates to the pilot that the remote aircraft 510 is still at a safe distance, but needs to maintain visual separation if possible. In this scenario, the distance between the local aircraft and remote aircraft decreased, which is represented on the screen as the remote aircraft getting closer to the local aircraft and crossing zones.

FIG. 5D illustrates a UI 500D displaying a scenario where the remote aircraft is within the Warning zone 555. The Warning zone indicates to the pilot that the remote aircraft is a potential threat, and to be aware of their position and be prepared to take corrective measures. In this scenario, the local aircraft speed increased from FIG. 5B, which triggered the device 100 to recalculate the zones, moving the remote aircraft 510 into the warning zone, even though the distance between the remote aircraft and local aircraft stayed the same. The remote aircraft 510 icon can signal the zone to the pilot by audio alarm, and/or pulsing icon 556. Default alarms may be configured to activate only when a remote aircraft enters the Danger zone.

FIG. 5E illustrates a UI 500E displaying a feature that allows the pilot to view additional information on the remote aircraft. A pilot selects any remote aircraft either by tapping on the screen, or selecting it from the left-hand side menu as mentioned in FIG. 5A. The additional information provided on the remote aircraft can include, the ground speed 576, heading 577, altitude 578, latitude and longitude 581, tail number 580 and the distance to the local aircraft 575. You can return to viewing the local aircraft information by tapping on the close button 590 in the top left corner.

FIG. 5F illustrates a UI 500F displaying a scenario where the remote aircraft crosses the boundary from the Warning zone into the Danger zone 560. The Danger zone indicates to the pilot that the remote aircraft poses an immediate threat to the local aircraft 505. The UI will sound an alarm 561 to alert the pilot to make immediate corrective maneuvers to avoid collision with the remote aircraft 510. The pilot can be alerted by various means provided by the device 100, such as an audio alarm, or the screen flashing. The pilot may choose to configure either or both such features.

While example embodiments have been particularly shown and described, it will be understood by those skilled in the art that various changes in form and details may be made therein without departing from the scope of the embodiments encompassed by the appended claims.

What is claimed is:

1. A method of tracking remote aircraft, comprising:
at a local aircraft, parsing a received signal, transmitted by a remote aircraft, to determine location data and velocity data indicating location and velocity of the remote aircraft;
determining a relative position of the remote aircraft as a function of a position of the local aircraft;
assigning the remote aircraft to a proximity zone as a function of 1) a distance between the local aircraft and the remote aircraft, 2) velocity of the local aircraft, and 3) velocity of the remote aircraft; and
displaying, at the local aircraft, 1) a representation of the remote aircraft positioned relative to the location and velocity of the local aircraft, and 2) a representation of the proximity zone encompassing the representation of the remote aircraft.

2. The method of claim 1, wherein the received signal is an automatic dependent surveillance-broadcast (ADS-B) signal.

3. The method of claim 2, further comprising parsing the ADS-B signal transmitted by the local aircraft to determine the position and velocity of the local aircraft.

4. The method of claim 1, wherein the proximity zone is one of a plurality of proximity zones, and further comprising displaying the plurality of proximity zones as a plurality of layers encompassing a representation of the local aircraft.

5. The method of claim 1, wherein the proximity zone is a first proximity zone, and further comprising, in response to detecting a change in velocity of at least one of the local aircraft and the remote aircraft, assigning the remote aircraft to the second proximity zone.

6. The method of claim 5, further comprising displaying, at the local aircraft, a representation of a movement of the remote aircraft from the first proximity zone to the second proximity zone.

7. The method of claim 1, further comprising emitting an audible cue in response to assigning the remote aircraft to the proximity zone, a characteristic of the audio cue being a function of the proximity zone.

8. The method of claim 1, further comprising, in response to an action by a user at the local aircraft, displaying information corresponding to the remote aircraft, the information including at least one of a speed, a name, and a heading of the remote aircraft.

9. The method of claim 1, further comprising updating the representation of the remote aircraft based on a change in the velocity of the local aircraft.

10. The method of claim 1, wherein the local aircraft and the remote aircraft are at least one of an airplane, a helicopter, a lighter-than-air vehicle, an advanced air mobility vehicle, a vertical take-off and landing (VTOL), and an unmanned aerial vehicle (UAV).

11. The method of claim 1, further comprising displaying the representation of the remote aircraft being positioned as a function of a position of a representation of the local aircraft.

12. A system for tracking remote aircraft, comprising:
a radio receiver configured to capture, at a local aircraft, a received signal transmitted by a remote aircraft;
a controller configured to:
parse the received signal to determine location data and velocity data indicating location and velocity of the remote aircraft;
determine a relative position of the remote aircraft as a function of a position of the local aircraft; and
assign the remote aircraft to a proximity zone as a function of 1) a distance between the local aircraft and the remote aircraft, 2) velocity of the local aircraft, and 3) velocity of the remote aircraft; and
a display configured to display, at the local aircraft, 1) a representation of the remote aircraft positioned relative to the location and velocity of the local aircraft, and 2) a representation of the proximity zone encompassing the representation of the remote aircraft.

13. The system of claim 12, wherein the received signal is an automatic dependent surveillance-broadcast (ADS-B) signal.

14. The system of claim 13, wherein the controller is further configured to parse the ADS-B signal transmitted by the local aircraft to determine the position and velocity of the local aircraft.

15. The system of claim 12, wherein the proximity zone is one of a plurality of proximity zones, and wherein the display is further configured to display the plurality of proximity zones as a plurality of layers encompassing a representation of the local aircraft.

16. The system of claim 12, wherein the proximity zone is a first proximity zone, and wherein the controller is further configured to, in response to detecting a change in velocity of at least one of the local aircraft and the remote aircraft, assigning the remote aircraft to the second proximity zone.

17. The system of claim 16, wherein the display is further configured to display, at the local aircraft, a representation of a movement of the remote aircraft from the first proximity zone to the second proximity zone.

18. The system of claim 12, wherein the controller is further configured to cause an audible cue to be emitted in response to assigning the remote aircraft to the proximity zone, a characteristic of the audio cue being a function of the proximity zone.

19. The system of claim 12, wherein the display is further configured to, in response to an action by a user at the local aircraft, display information corresponding to the remote aircraft, the information including at least one of a speed, a name, and a heading of the remote aircraft.

20. The system of claim 12, wherein the controller is further configured to update the representation of the remote aircraft based on a change in the velocity of the local aircraft.

21. The system of claim 12, wherein the local aircraft and the remote aircraft are at least one of an airplane, a helicopter, a lighter-than-air vehicle, and an unmanned aerial vehicle (UAV).

22. The system of claim 12, wherein the display is further configured to display the representation of the remote aircraft being positioned as a function of a position of a representation of the local aircraft.

23. A computer-readable medium storing instructions that, when executed by a computer system, cause the computer system to:
parse a received signal at a local aircraft, transmitted by a remote aircraft, to determine location data and velocity data indicating location and velocity of the remote aircraft;
determine a relative position of the remote aircraft as a function of a position of the local aircraft;
assign the remote aircraft to a proximity zone as a function of 1) a distance between the local aircraft and the remote aircraft, 2) velocity of the local aircraft, and 3) velocity of the remote aircraft; and
display, at the local aircraft, 1) a representation of the remote aircraft positioned relative to the location and velocity of the local aircraft, and 2) a representation of the proximity zone encompassing the representation of the remote aircraft.
